(19) United States
(12) Patent Application Publication
(10) Pub. No.: US 2013/0099074 A1
(43) Pub. Date: Apr. 25, 2013

(54) DEVICE FOR IMMOBILIZING ROADSIDE WASTE CONTAINERS

(71) Applicants: Jose Leston Gutierrez, Santander (ES); Jose Antonio Poncela García, Santander (ES)

(72) Inventors: Jose Leston Gutierrez, Santander (ES); Jose Antonio Poncela García, Santander (ES)

(73) Assignee: COMERCIAL ESPAÑOLA DE ANCLAJES Y SUJECIONNES, S.L, Santander, Cantabria (ES)

(21) Appl. No.: 13/806,905

(22) PCT Filed: Jun. 30, 2011
(86) PCT No.: PCT/ES2011/000218

§ 371 Date: Dec. 26, 2012

(30) Foreign Application Priority Data
Jul. 1, 2010 (ES) P201000869

(51) Int. Cl. B65F 1/14

(52) U.S. Cl. CPC B65F 1/141
USPC 248/205.1

(57) ABSTRACT

Device for immobilizing roadside waste containers, composed of two bodies of similar or identical forms, one of said bodies—receptacle (A)—being inserted in the bottom of the container, the base thereof being screwed thereto and there being an exit to the outside when a hole is made in the container; which receptacle body allows insertion, within, of a complementary body (B) securely fastened to the ground; which coupling will prevent movement of the container. The receptacle and complementary bodies will have a pyramidal form, one fitting inside the other when the container descends after tipping out into the refuse-truck receiving body.

### OBJECT OF THE INVENTION

The present invention relates to a device for holding roadside waste containers, by immobilizing them against strong winds, torrential rains or vandalism; while allowing the waste containers to be emptied by refuse trucks and quickly and easily returned to their original location.

### BACKGROUND OF THE INVENTION

Waste containers are often found in the middle of the street, spilling their contents onto the street, instead of in the spaces reserved for them on the sidewalk.

They may have been pushed along by bad weather, or for fun in the case of vandalism. They are a clear risk to drivers, and public money is used to clean the waste dumped in the street and to return the waste container to its original location on the sidewalk. They are also an eyesore for the city.

There are various state-of-art solutions to the problem, which use different methods to hold the container and prevent its movement. Spanish patent P200200672 is a retention method using a group of posts which are each anchored to the ground and have slots to accommodate the knobs found on each side of the containers, which are then grasped by the arms on the refuse trucks to dump the waste into the truck. The invention uses the knobs to fit within the described slots. The knobs must be unlocked using a special key to be handled by authorized personnel.

Utility Model 20200600173 shows a structure for holding containers in the right-of-way using a tube with two ends which are anchored to the ground; the tube structure is shaped to hug the form of the container, leaving an open area for lifting the container, and means for opening and closing this area.

Utility Model 200100805 is a means to anchor the container to a structure consisting of a post anchored to the ground with a horizontal bar on the top having the same size as the container. The bar has hooks on each end to attach to the knobs on the container.

Utility Model 200002985 is a brace anchored with screws or set into the ground. The brace hooks onto the back of the container with a u-shaped piece similar in form and function to the brace.

Other inventions include a variety of tubular structures on a vertical element, which are swung down to hug the container or lifted to release it. An example of this type of invention is Utility Model 200400254.

All of the aforementioned inconveniently require the work of an operator to unhook the container and then return it to its brace after tipping it out into the refuse truck. Presently, refuse trucks have two arms which lift the container using the knobs on the sides, and tip it out. This can be done with just one operator, the truck driver, who parks his vehicle alongside the container and empties it directing the two arms from the cab of the vehicle. If the container were held by one of the aforementioned braces, another worker would have to release the container and then return it to its brace, as stated above.

We will end by addressing Utility Model 9501948 which uses a frame comprising a ring into which the container is set to hold and stabilize the container. The frame is rectangular, and is slightly larger than the base of the container, with a small flange on the upper edge for the container to fit into. The inconvenience of this device is that existing containers vary in size and shape, some also having wheels which vary in size. The frame works with only one specific container, and existing containers would not work.

### DESCRIPTION OF THE INVENTION

The present invention responds to the problems of existing models. This is done with a device comprised of two bodies to be installed in the container; one is placed into the bottom of the container, making a hole in the container having the same dimensions as the base of the body to be installed. This body will the receptacle to the other complementary body found on the ground, and both having similar or identical shapes, the smaller one will fit into the receptacle body.

The body placed on the bottom of the container is open on its base to receive the complementary body which is fastened to the ground, usually on the sidewalk of the right-of-way. Upon installation of the two bodies of the device, receptacle body and complementary body, the container will be immobilized in its location, and will not be moved by strong winds or other such inclement weather.

The device also prevents movement or tipping by vandals. Moving the container would require lifting it straight up, along with all of its contents, in order to disengage the receptacle body, located on the base of the container, from the complementary body, fastened to the ground and inserted within the receptacle body.

Said device allows for the placement of the device in all existing containers, without having to modify their structure. The installation is simple, requiring only the making of a hole in the bottom of the container to place the receptacle body and fasten it to the structure. The complementary body to be inserted within the receptacle will be fastened to the ground.

The invention can be installed in any of the containers to be found in the public right-of-way, given that they logically all have bases, and the installation does not require any specific shape or size of container. Some containers found in the right-of-way have wheels, of varying sizes, which do not prevent the installation of the invention.

### DESCRIPTION OF THE DRAWINGS

To accompany this description and to improve understanding of the features of the invention, the following descriptive record with plans has been prepared to show a preferred embodiment, which, by way of illustration and not limitation, the following have been provided:

FIG. 1.—View of the device of the present invention comprising a receptacle body (A) and a complementary body (B) to be inserted into the receptacle body. The receptacle body (A) is shown as a section, and the complementary body (B) with a front view of a partial section of the drilled area.

FIG. 2.—Shows the receptacle body (A) in the container and the complementary body (B) in the ground.

FIG. 3.—Shows the device with its two bodies, one fit into the other.

FIG. 4.—View of the device installed in a container with wheels.

FIG. 5.—View of a container, with the receptacle body (A) installed at the center of its base to fit over the complementary body (B).

### PREFERRED EMBODIMENT OF THE INVENTION

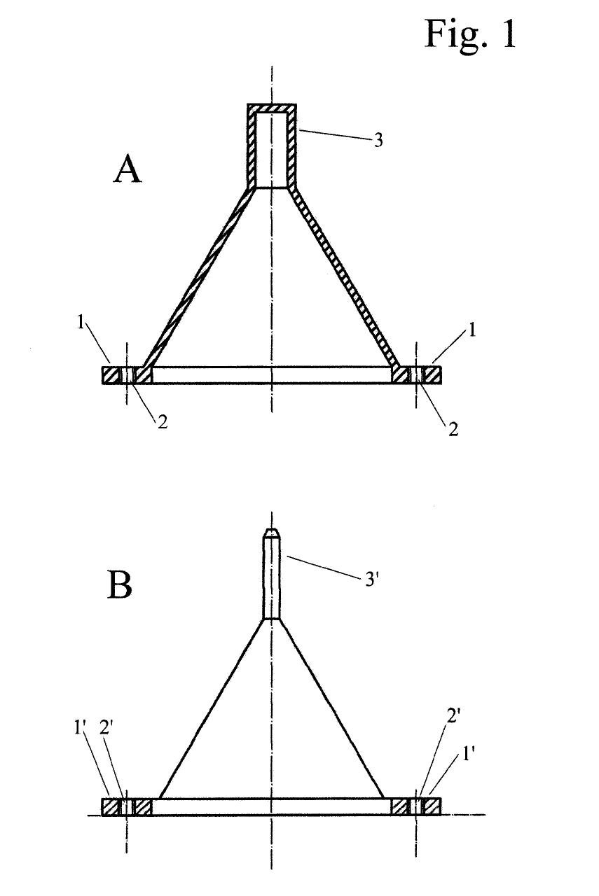

As seen in the drawings, the device of the present invention, FIG. 1, is comprised of two bodies; one referred to as the receptacle body (A), which is hollow and shaped to allow the insertion, at its base, of another smaller body of identical or similar shape, referred to as the complementary body (B).

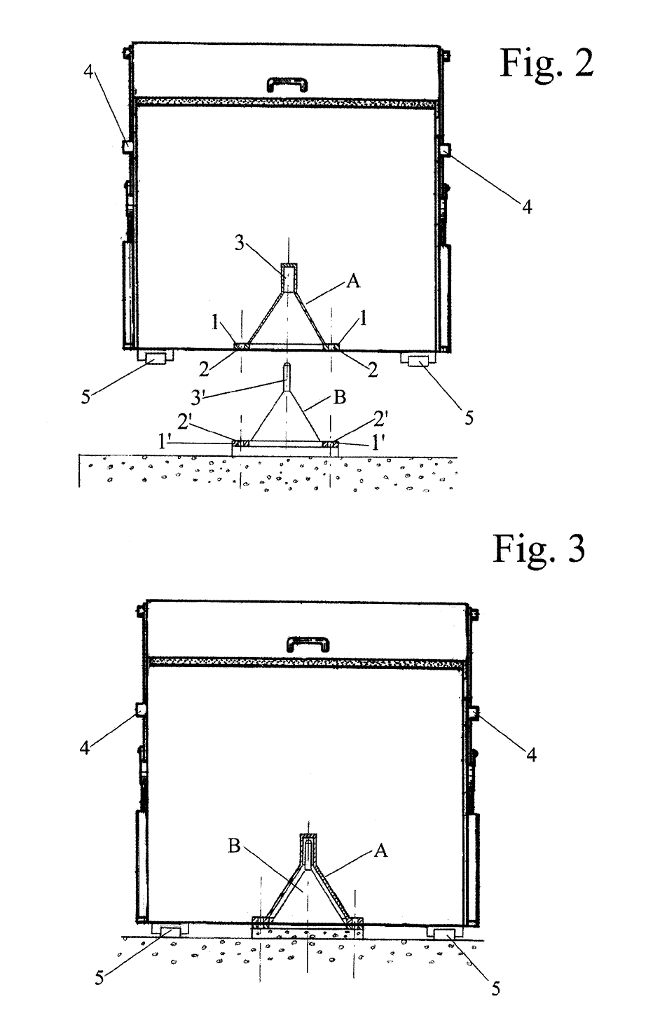

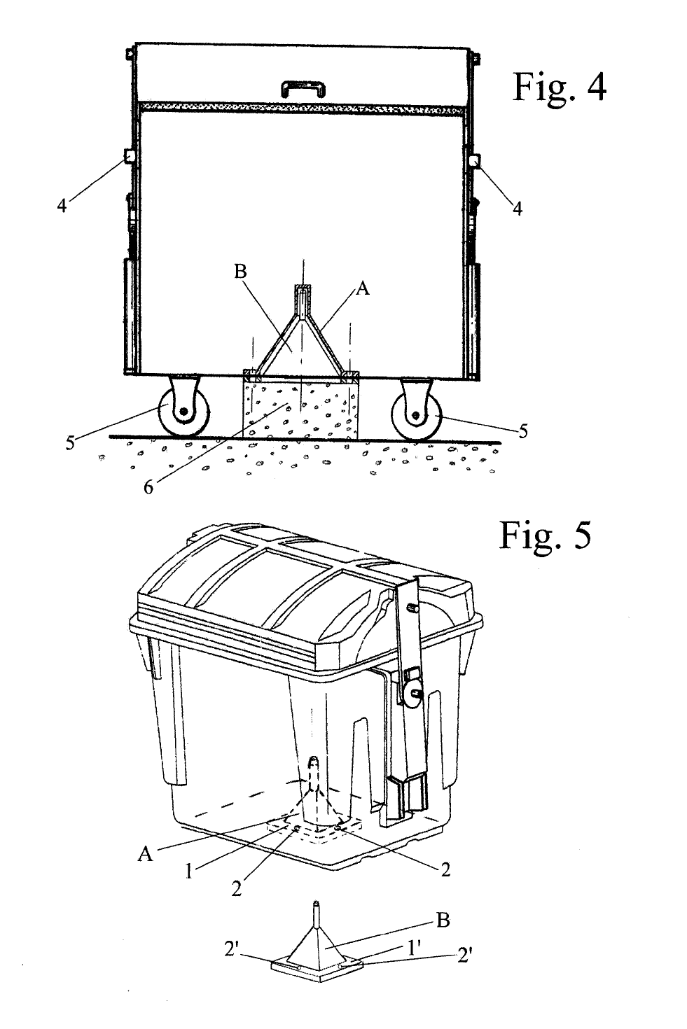

The bodies of the device will preferentially have a pyramidal form, and the receptacle body (A) will be installed in the middle of the base of the container, FIG. 5, making a hole in the bottom of the container to screw the receptacle body (A) which is then fastened with screws. The complementary body (B) will be fastened to the ground, positioned to fit within the receptacle body, FIG. 2.

The receptacle body (A) will be fastened to the container and the complementary body (B) to the ground, using flanges (1,1′) on the perimeter of the bases of each body, where screws will be used in the drilled holes (2,2′) found on each of the flanges (1, 1′).

Bodies A and B of the device each have, opposite the bases, in this embodiment, an extension in the form of a tubular cylinder (3, 3′) at the tip of the pyramid, to fit the extension of the complementary body (B) into the receptacle body (A) when they are united. This extension provides a surer fit between the two bodies of the device and improved immobilization of the urban waste container.

The tipping of the container into the refuse truck will be done by placing the truck in the correct position for its two arms to reach the bottom of the two knobs (4) on the sides of the container, next the arms will be lifted, raising the container, and thereby tipping the contents into the refuse truck; and lastly lowering the arms to place the container back into its location, atop the complementary body (B). The pyramidal shape, in the preferred embodiment, of the receptacle body (A) and the complementary body (B), respond to the possible deviations that the container could take on its return to the complementary body (B), after the tipping of its contents into the refuse truck, which will be corrected by the shape, which forces the receptacle body (A) placed in the container to fit over the complementary body (B), fastened to the ground, and allows the coupling of the two extensions (3, 3′). The pyramidal shapes prevent any turning or rotation of the receptacle body over the complementary body.

The device can be installed in any of the existing types of containers. Some of the containers have wheels (5) which vary in the distance from the ground to the base of the container for each type of container, depending on the wheel height. In these cases a foundation (6) would be installed with adequate height to complete the distance between the ground and the base of the container. The complementary body (B) would be placed on said foundation (6).

Another embodiment which would be obvious to any expert in the area would be to install the receptacle body (A) in a hole made in the asphalt, with its base level to the ground, and the complementary body (B) on the container to be inserted into the receptacle body.

Upon completing an exhaustive description of the present invention, we should mention that it can be modified in shape, size and material, whenever said modifications are not substantially different from the following characteristics:

1. In combination with a roadside waste container having a hole at its bottom, a two-part device for immobilizing said container, said device including a first part which is comprised of a hollow receptacle body, said hollow having a first pyramidal shape and a second part having a second pyramidal shape smaller in size than said first pyramidal shape; said second part adapted to be installed in the ground and the first of said two parts being adapted to be installed in said hole at the bottom of the container; the receptacle body of said first part being open at its base, and placed in said hole in the bottom of the container, with the base of the receptacle body facing out, to receive the complementary body which is adapted to be installed in the ground.

2. Device for immobilizing containers, in accordance with claim 1, wherein the receptacle body and the complementary body each have a cylindrical tubular extension at the end opposite from the base.

3. Device for immobilizing containers, in accordance with claim 1, wherein the receptacle body and the complementary body have a flange on the perimeter of their bases, said flanges having screwholes that allow for the placement of screws in the flange to fasten the receptacle body and the complementary body.

4. For use with a roadside waste container, a two-part device for immobilizing said container, said device including a first part which is comprised of a hollow receptacle body, said hollow having a first pyramidal shape, and a second part having a second pyramidal shape smaller in size than said first pyramidal shape; one of said parts adapted to be installed in the ground and the other of said two parts being adapted to be installed at the bottom of the container; said receptacle body of said first part being open at its base, and placed with the base of said receptacle body facing out, to receive said complementary body.

5. Device for immobilizing containers, in accordance with claim 4, wherein said receptacle body and said complementary body each have a cylindrical tubular extension at the end opposite from the base.

6. Device for immobilizing containers, in accordance with claim 4, wherein said receptacle body and said complementary body each have a flange on the perimeter of their bases, said flanges having screwholes that allow for the placement of screws through the flange to fasten said receptacle body to said complementary body.
